(19) United States
(12) Patent Application Publication
(10) Pub. No.: US 2016/0050309 A1
(43) Pub. Date: Feb. 18, 2016

(54) RESTRICTIVE CELL PHONE USE AND ANTI-TEXTING APPARATUS AND METHODS

(71) Applicant: Lance L. GOOBERMAN, Merchantville, NJ (US)

(72) Inventor: Lance L. GOOBERMAN, Merchantville, NJ (US)

(21) Appl. No.: 14/458,678

(22) Filed: Aug. 13, 2014

(51) Int. Cl. H04M 1/725; H04B 5/00; H04B 1/3822

(52) U.S. Cl. CPC H04M 1/72577; H04B 1/3822; H04B 5/0031

(57) ABSTRACT

Provided is a communications device system for simultaneously enabling and disabling a vehicle and a mobile communications device, the vehicle being for transporting at least a vehicle operator, the vehicle having an enabled mode for permitting motion of the vehicle and a disabled mode for preventing motion of the vehicle, the system comprising: mobile communications device for transmitting and receiving communication signals, the communications device having a fully operational mode for permitting transmission and reception of communication signals and an idle mode for preventing transmission of communication signals; a receiving receptacle secured within the vehicle and configured for receiving and securing the communications device within receiving receptacle so that the communications device is in the idle mode whenever the communications device is secured within the receiving receptacle; and, a vehicle enabling mechanism secured within the receiving receptacle and secured in communication with one or more operating components of said vehicle, the vehicle enabling mechanism being configured so that placement of the communication device into the receiving receptacle activates the vehicle enabling mechanism to put the vehicle in the enabled mode, and so that removal of the communication device from the receiving receptacle deactivates the vehicle enabling mechanism to put the vehicle in the disabled mode by way of RFID.

### FIELD OF THE INVENTION

This invention relates to the apparatus and methods to inhibit, or prohibit, use of a hand held communication device such as a cell phone while driving or operating a vehicle or water craft that is in motion at any speed, and in particular to inhibit or prohibit texting by a vehicle and/or water craft operator while the vehicle and/or water craft is in motion at any speed.

### BACKGROUND OF THE INVENTION

Texting while driving, or otherwise use of a cell phone including engaging in various visual-manual subtasks, such as talking, reading and using maps, using a navigation system, watching a video, adjusting a music player on a smart phone and the like, while operating a motor vehicle, or water craft, or even recreational vehicles, such as ATVs, is commonplace, and has become the source of many unnecessary and otherwise preventable accidents, many of which are fatal to the operator and others. This problem has reached epidemic proportions, especially with persons of younger age with the average teenager thought to be sending and receiving five times more text messages a day than a typical adult.

The use of a cell phone while operating a vehicle is now illegal in several states, but still such use continues with attendant accidents and fatalities mounting. As recent as 2010, for example, approximately one-fifth of all car and truck accidents involved operators talking on both hand held and hand free cell phones. An additional 3% involved texting operators, and through 2012 it was estimated that accidents involving drivers using cell phones and texting occurs on average every 24 seconds. It is also thought that engaging in visual-manual subtasks, such as reaching for a phone, dialing and texting, associated with the use of handheld phones and other portable devices increases the risk of getting into an accident by three times the norm.

Many devices and methods to inhibit or prohibit the use of a cell phone by an operator and to inhibit or prohibit texting or other visual-manual subtasks while driving are known, such as the idea that a master control device placed in a car or truck or rental vehicle might automatically deactivate a smart phones' ability to be used or to text. For example, an application is known that will disable phone texting if it detects vehicle motion above 10 miles per hour. Ensure's Drive Off app is said to prevent distracting while driving, by detecting once an auto reaches 10 m.p.h. the app will automatically turn off all notifications and incoming calls and display a static screensaver. The driver must download the app and choose a screensaver, and thereafter the app will detect the act of driving. Another app from AT&T is said to perform in similar manner once a driver reaches 25 m.p.h. This app is AT&T Drive Mode, and as with the ensure app, this app must be downloaded by the driver which will automatically send customizable auto-reply messages to incoming texts, and which is said to inform others that driving of the vehicle is in process and a reply will be forthcoming when its safe to do so. In some modes, one can receive text alerts on their phones when the AT&T Drive Mode has been turned off while the vehicle is moving.

Operating in a different mode is Scosche Cell Control which is an apparatus that plugs into a car's OBD-II port (if the driver has a 1996 or later model vehicle) which is said to sense when the vehicle is in motion, and if so, is said to more or less disable the driver's phone, rendering e-mail, texting, phone calls, web access, camera capabilities and more useless once the car is in motion. Music playing apps and the ability to make and take calls using a hands-free headset will remain unaffected. This system reportedly will not work with I-phones, however, and only works with most current Android and Blackberry phones. The device must be installed in the car and an app downloaded on the phone that is contemplated to be disabled when the car is in motion. Should the device be attempted to be removed an e-mail will be automatically sent to an administrator, such as child's parent.

Text Buster by Access 2 Communications Inc. works on a principle of mobile phone jamming technology or blocking a cell phone from communicating with a signal tower, and entails text-blocking capability. Active blocking of a cell phone from communicating with a signal tower is illegal in the U.S., and passive blocking, while intentional or not, such as when a building construction site inhibits or blocks a cell phone's signal, is also questionable. While not a typical jammer, the Text Buster device employs a Bluetooth module to identify a pre-paired device running the Text-Buster app, and which in turn is said to disable all the data functions, including text messaging, e-mail and internet access. However, the operator of the motor vehicle is still able to place or receive calls, and use a GPS for mapping purposes, which provide for distraction and risks problems in and of themselves. The app is also said to be password protected, and if tampered with or removed, and SMS alert will be sent to a monitor. In operation two apps are down loaded to a user's phone, the main Text Buster application and a Text Buster watch dog app, which notifies the account manager (parent, guardian or company fleet manager, as the case may be) if either application is removed, and an SMS message notifying of removal or foreclosure automatically sent. Should a user attempt to disable the Bluetooth or his phone prior to getting into the vehicle, the phone will “lock” and instruct the user to re-enable Bluetooth, and also inform the monitoring server if Bluetooth has been turned off, or if the user rebooted the phone. The Text Buster app is only active when the vehicle is running, however, permitting a driver to park, turn off the vehicle, wait several seconds and have the data functionally re-enabled. The device can also be programmed to handle multiple phones.

A recent (2014) U.S. Pat. No. 8,706,143 issued to Apple Inc. employs similar “lock-out” mechanisms for driver handheld computing devises, which is said to disable the ability of a handheld computing device to perform certain functions, including texting, while driving. In one embodiment a lockout mechanism is provided without requiring any modifications or additions to a vehicle by using a motion analyzer, a scenery analyzer and a lock-out mechanism. In other embodiments, the handheld computing device can provide a lock-out mechanism including modifications to the vehicle, such as, the use of signals transmitted by the vehicle or by the vehicle key which engaged with the vehicle, or in other words similar motion detection technology already described.

Text Limit provided by the state of Kentucky is an app which is said to work with a smart phone's global positioning software to determine the speed of a vehicle in use, and when a vehicle reaches a pre selected speed limit the smart phone's touch-screen is inhibited, and which is then supposed to reduce the likelihood of distracted driving-related crashes. The Text Limit app works with both Apple and Android devices and is available free of charge to all Kentucky licensed drivers, available for a fee for non-Kentucky drivers and can be downloaded from the Apple App Store, Google Play Store and TextLimit.com websites. Currently Text Limit is the only commercially available app for the iPhone that inhibits or stops distracted driving. Other features of Text Limit include: settings can only be programmed by the administrator; attempts by a user to disable or tamper with Text Limit automatically activates an email or text message to an administrator; the Text Limit administrator can set the speed at which the device's touch screen is deactivated, thus making texting and driving and phone calling impossible; the administrator is empowered to customize certain incoming telephone numbers; the administrator or other approved callers can ring-through to the phone, at any time; Text Limit GPS connectivity allows the administrator to locate a programmed device at any time; and, by default TextLimit.com broadcasts the device's location every five minutes with 9-1-1 emergency call functions always remaining active.

While such devices described above designed to stop texting while driving by blocking text message signals when the phone is in the car, another product ORIGO Safe entails a different approach wherein unless the phone is plugged into the device, the car will not start. As a user drives, the device charges the phone and only allows a driver to make or receive calls via Bluetooth. If the phone is removed while driving it will trigger an alarm and alert a system administrator, such as a parent or manager. Consequently, that user will be locked out of the system and unable to start the car on a subsequent trip, with only the administrator able to unlock the feature. If a parking brake is engaged with the vehicle idling the device will allow the phone to be removed.

Yet another anti-texting device from Quiet Zone is said to employ non-invasive wireless technology to automatically adjust a cell phone's settings when the user enters a so called “Quiet Zone”, such as a school district or roadside construction site, with various settings changes ranging from silencing of ringers and lowering of screen brightness to the prevention of text messaging. The range for preventing texting and driving is said to be a few meters, and when used in buildings the range is said to be over 100 meters.

Still yet another device from Safe Driving Technologies is said to prohibit texting while driving by disabling a phone while a vehicle is in use, and again is a plug in device that works in any car made after 1996. The device activates when the car is on, and automatically puts the cell phone in “safe driving mode” by disabling text messages, with incoming calls going to voicemail and incoming text messages responded to automatically that the recipient is driving and will respond later. As with other devices if the device is unplugged a report is sent to an administrator. As a safety feature, if 911 is called everything will automatically unlock such that the driver can be called back.

Still more devices or downloadable apps to prohibit texting and other distractive activities while driving are iZUP, which like other similar apps completely disables a phone, except to dial 911 or one of three other pre-approved numbers; Txiblocker which is downloadable software allows one to set time and location restrictions for texting or other cell phone use while enabling a list of pre-approved numbers that can be called anytime; Call Safety, is yet another downloadable app which disables one's cell phone while driving, and which can be set up to block text messages in certain selected zones, such as a school zone, and contains a variety of parental controls and GPS tracking; Textcaution, which employs a phones GPS detection of moving faster than 10 m.p.h. to disable texting function, and depending on your status as a passenger or, for example, riding a bus, one can ask for permission to text from the account administer who would be able to override the restrictive software; and Otter, which like other apps, offers the ability to disable phone capabilities when it detects the phone reaching a certain speed with the option to send an automated text reply, and also offers parent-enabled pass codes and a manual mode to let users rapidly offer a preprogrammed reply.

While all of the afore-mentioned devices and various technologies, and others on the market or available for use, are no doubt useful and effective in some ways, there currently exists much room for improved technologies and devices to inhibit and/or prohibit the use of distractive activities on handheld devices while operating motor vehicles, water craft, trains, airplanes, ATVs and the like to prevent the unnecessary occurrence of accidents to both operators and non-operators alike.

### SUMMARY OF THE INVENTION

The present invention resolves the problem of operators of vehicles, including in this definition any one or more of automobiles, trucks, water craft, trains, airplanes, motorcycles, trikes, RVs including three and four wheel versions (“quads”) and the like, in using cell phones or other mobile devices (hereafter, collectively “cell phones”) while engaging in various visual-manual distractive activities, including but not limited to, talking, reading, texting, e-mailing, map using, using a navigation system, watching a video, and/or adjusting a music player, by providing a cell phone system for enabling and disabling at different times the cell phone and a vehicle. The vehicle, such as an automobile, is for transporting at least a vehicle operator and, of course, may include one or more passengers, and the vehicle has an operational mode for permitting motion of the vehicle and a disabled mode for preventing motion of the vehicle or at least one or more operational functions of the vehicle which inhibit or prevent vehicle motion upon attempted initial operation of a vehicle. The cell phone system includes a cell phone for transmitting and receiving communication signals, wherein the cell phone has a fully operational mode for permitting transmission and reception of any and all communication signals and a limited function or off mode for preventing transmission of some or all communication signals or use of the cell phone, except for the optional transmission of 911 or emergency calls. The system may also include a receiving receptacle secured within the vehicle and configured for receiving the cell phone within the receiving receptacle so that the cell phone is in the restricted or off mode whenever the cell phone is within the receiving receptacle. A vehicle enabling mechanism is secured within the receiving receptacle and is also secured in communication with an operational component of the vehicle, such as ignition coil, fuel injection or brake locks, preferably in a wireless mode, such as, but not limited to, an RF (radio frequency) mode, specifically Radio Frequency Identification or RFID, inclusive of any RFID frequency in the electromagnetic spectrum, such as Ultra High Frequency (UHF) in some preferred embodiments, Low Frequency (LF) and/or High Frequency (HF) in other preferred embodiments, and in still other preferred embodiments of the invention GPS tracking technology and/or Near Field Communication (NFC) technology. The vehicle enabling mechanism is configured so that placement of the cell phone within a receiving receptacle (there may be one or more depending on a preferred embodiment) activates a vehicle enabling mechanism (of which there also may be one or more) to put the vehicle in a fully operational mode, and so that removal of the cell phone from the receiving receptacle prior to attempted operation of the vehicle deactivates at least one or more operational components or functions of the vehicle which inhibit or prevent vehicle motion, referred to herein as “the vehicle enabling mechanism” to put the vehicle in the disabled mode.

In use of the present cell phone system for enabling and disabling a vehicle, the cell phone acts in an analogous manner as an antitheft device for operation of a vehicle which as mentioned, such as in an automobile, will upon attempted operation of the vehicle, for example, disable one or more operating components of a vehicle, for instance, locking up the brakes, disabling the ignition coil, disabling fuel injection, disabling steering, and the like or any combination thereof to prevent or inhibit initial vehicle operation.

Additionally, should the cell phone system be tampered with in any way, the system will act in an analogous manner to car breathalyzer devices or Ignition Interlock Devices (IID) which prevent a vehicle from starting should an operator's breath alcohol level be detected over a preset level. Additionally, if alcohol is detected over limit while driving in a random test and/or if the device is tampered with, the device may set off an alarm, trigger the vehicle's horn and/or flash its headlights/taillights until the vehicle is turned off. For safety reasons such IIDs will not disable the vehicle while being operated, but it remains an option of notification of an administrator, e.g. police station, if the device is tampered with.

The cell phone devices of the present invention may be provided with the same functionality/capability, in that should the cell phone while in a receptacle be tampered with in any way, or should any part of the cell phone system be tampered with in any way during or at any point during vehicle operation, including tampering with any sensors in the receiving receptacle, the device may set off an alarm, trigger the vehicle's horn and/or flash its headlights/taillights, etc., but with the vehicle's moving operation not hindered in any way for safety reasons, and an administrator optionally notified.

The receiving receptacle may also include a receiving receptacle lock mechanism that is in communication with operational components of the vehicle so that the receiving receptacle locks the cell phone within the receptacle whenever the vehicle is moving. Such a motion based lock may be based on such locks now common in modern vehicles to lock doors of the vehicle for security during travel, and control of this option can readily be applied to the receiving receptacle to prevent removal of the cell phone from the receptacle during operation of the vehicle.

The present cell phone system may also include a receiving receptacle by-pass mechanism, such as a credit card sized card or code entry held and/or used by one or more non cell-phone restricted or non-vehicle operating passengers, and inserted and/or code entered into the receiving receptacle to activate the vehicle operational mechanism within the receptacle and phone operational features. For example, the receiving receptacle by-pass mechanism would enable the parents and/or older, non cell-phone restricted drivers or non-vehicle operating passengers usage of their cell phones without restrictions during vehicle operation.

The wireless vehicle disabling/enabling mode, such as RFID functionality, may also be coupled to a scenery analyzer which may be configured to determine whether a holder of a cell phone or other communication device is located within a safe operating area of a vehicle, such as described in U.S. Pat. No. 8,706,143. In this embodiment the RFID signal coupled with an app in place will be configured to disable one or more functions of a restricted communication device, such as any of visual-manual sub-tasks inclusive of talking, reading, texting, e-mails, using maps, using a navigation system, watching a video, and adjusting a music player functionality, as based on the output of the RFID analyzer, while enabling one or more such visual-manual subtasks on selected non-restricted communication devices based on the output of the scenery analyzer.

Unlike known approaches to restricting cell phone usage by a vehicle operator that disrupt or curtail the operation of a cell phone, of the present cell phone system for enabling and disabling at different times cell phone and vehicle operation is based on wireless tracking technology, such as Radio Frequency Identification (RFID), (any frequency), GPS and/or Near Field Communication (NFC). This system will therefore resolve the most pressing need of parents or guardians or employees of certain drivers by only disabling use of one or more specific cell phones of one or more drivers while driving or operating a vehicle over which, for example, the parents or guardians or employees seek to assert control. The present system also permits ordinary cell phone usage by non-vehicle or otherwise non-operators within the vehicle, including all normal visual-manual subtasks, such as phone conversation, e-mails, texting and the like thereby providing increased security, efficiency and convenience. The cell phone system of the present disclosure achieves these goats economically and with modest complexity, and can be readily retro-fitted into common vehicles and with little or no modification of the restricted cell phone or phones, and can be used with any model cell phone currently in use anywhere and future use whether contemplated or not at the present time.

### BRIEF DESCRIPTION OF THE DRAWINGS

FIG. 1 is a perspective view of an embodiment of a cell phone system for enabling and disabling various visual-manual subtasks of a cell phone and operational components of a vehicle at different times.

FIG. 2 is a perspective fragmentary view of a typical vehicle front interior showing a partial driver/operator's area and front seat passenger's area, including a representation of an embodiment of the present cell phone system installed in the vehicle for enabling and disabling various visual-manual subtasks of a cell phone and operational components of a vehicle at different times.

FIG. 3 is perspective view of an embodiment of a receiving receptacle of the present invention showing the receptacle open, and showing a schematic representation of a cell phone to be installed in a receiving receptacle and also illustrating vehicle enabling/disabling mechanism and a cell phone enabling/disabling mode secured within the receptacle.

### DESCRIPTION OF PREFERRED EMBODIMENTS OF THE INVENTION

In the following description of preferred embodiments, reference is made to accompanying drawings where it is shown by way of illustration specific embodiments in which the invention can be practiced. It is to be understood that other embodiments can be used and structural changes can be made without departing from the scope of the embodiments of this invention.

Although some embodiments of this invention may be described and illustrated herein in terms of a lock-out mechanism to disable text messaging, it should be understood that embodiments of this invention are not so limited, but are generally applicable to disabling any function of a handheld computing device that may interfere with the safe operation of a vehicle by a driver, such as receiving or placing cellular telephone calls with a hands-free device, for example. Further, although some embodiments of this invention may be described and illustrated herein in the context of an automobile, it should be understood that embodiments of this invention are not so limited, but are generally applicable to any vehicle, such as trains or airplanes, for example.

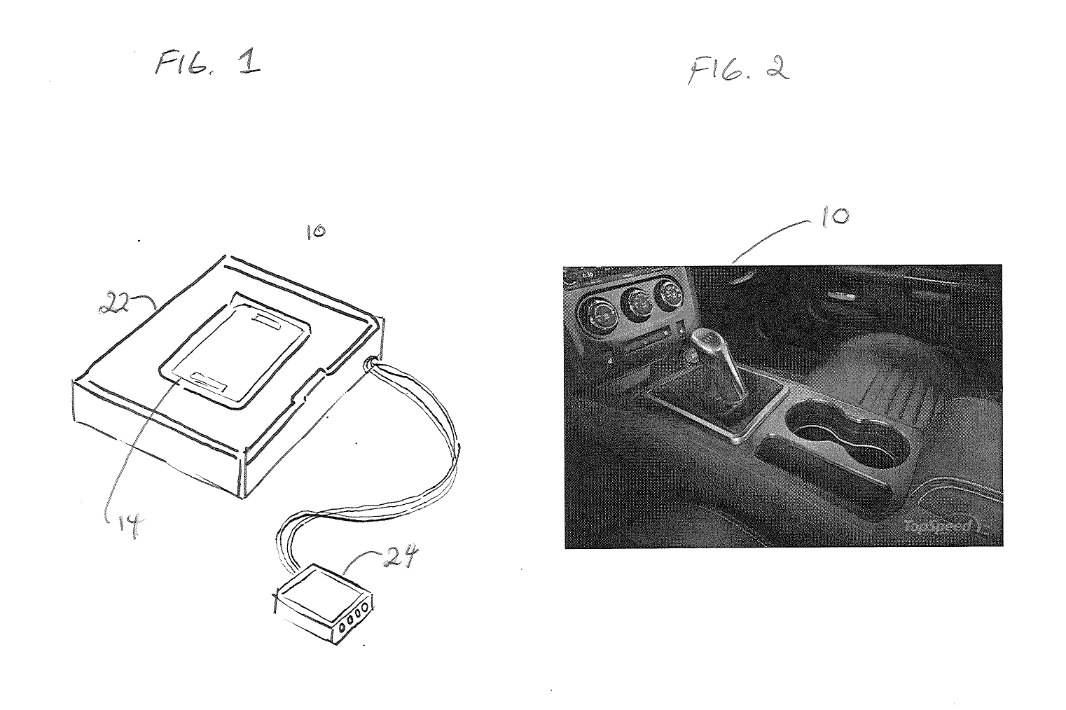

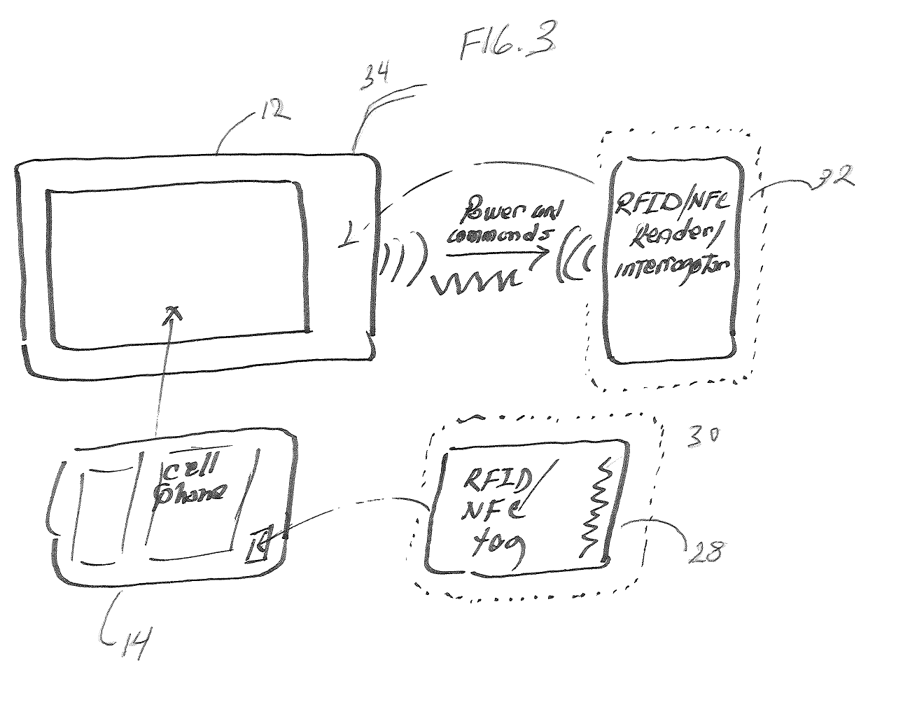

Referring to the drawings in detail, a cell phone system for enabling and disabling various visual-manual subtasks of a cell phone and operational components of a vehicle at different times is shown in FIG. 1, and is generally designated by the reference numeral 10. The cell phone system 10 comprising a receiving receptacle 12 for placing a cell phone 14 is typically deployed within a vehicle as shown in FIG. 2, which depicts a typical vehicle front interior showing a partial driver operator's area adjacent to a transmission shifter and steering wheel (not shown) and a front seat passenger area wherein the vehicle, such as an automobile, and is configured for transporting at least a vehicle operator adjacent to a steering wheel within an operator's seat of the vehicle. The inhibition of receptor transmission of communication signals from or to the cell phone 14 is controlled by one or more signal-based apps supplied from receiving receptacle 12, as shown in FIG. 3. The vehicle has an operational mode for permitting one or more operating components for enabling motion or operation of the vehicle and a disabled mode for preventing operation of one or more operating components for enabling motion or operation of the vehicle.

The cell phone system 10 with a cell phone 14 for transmitting and receiving communication signals, placed within receiving receptacle 12, has a fully operational mode for permitting transmission and reception of communication signals including but not limited to, various visual-manual subtasks such as talking, reading, texting, e-mailing, map using, using a navigating system, watching a movie and adjusting a music player and the like. The cell phone 14 when placed within receptacle 12 has a limited function mode, or off mode, for preventing receipt or transmission of communication signals, such as for prevention of operation of any one or more visual-manual subtasks, including talking, reading, texting, e-mailing, map using, using a navigation system, watching a video, adjusting a music player, and the like. For purposes herein, the phrases “limited function” or “off mode”, mean that the cell phone 14 is incapable of receptor transmission of communication signals of any one or more said visual-manual subtasks, especially texting. The cell phone 14 may be any commercially available phone, such as any model of an iPhone or any Android operating phone, such as any model of a Samsung Galaxy.

The cell phone system 10 with receiving receptacle 22 is secured within the vehicle, such as on or inside a center console 16 of the vehicle (as shown in FIG. 2), or, for example, on or within a dashboard of the vehicle or in a glove compartment or anywhere deemed convenient. The receiving receptacle 12 may also include in an embodiment a locking means defined within the receptacle. The receptacle 22 may also include in a preferred embodiment non-rigid resilient contact material secured to interior surfaces of receptacle 22 for cushioning the cell phone 14 and for securing the phone 14 in a fixed position whenever the phone is placed within the receptacle 22. The resilient contact material may be any sponge like or plastic foam substance suitable for minimizing shock damage to the cell phone 14 while simultaneously securing the cell phone 14 against movement within the closed receptacle. While the cell phone 14 is so placed within the receiving receptacle 22, the cell phone 14 is in its restricted or off mode so it cannot receive or transmit communication signals, except, for example, emergency or 911 calls or communication signals.

As shown in schematic layout form in FIG. 3, a receiving receptacle 12 is provided for placement of a cell phone 14. As shown in partial enlarged form by way of dotted lines the cell phone 14 has, in this embodiment, an embedded RFID/NFC tag 28 which contains an antenna 30.

The tag 28 in this embodiment, which may be an NFC passive tag, communicates with interrogator/reader 32, shown in partial enlarged form by dotted lines, and which interrogator/reader 32 is embedded in an end portion of receiving receptacle 12. Placement of cell phone 14 in receptacle 12 will alert the system 10 of the presence of cell phone 14 by way of interrogator/reader 32 communicating with tag 28, and which will activate an app to then simultaneously, or at least substantially simultaneously, disable one or more visual-manual cell phone communication functions, such as texting, and enabling vehicle operating components for vehicle operation.

In its broadest sense, the present invention in placing a cell phone in a restricted or off mode while in a receiving receptacle, and to essentially simultaneously place the vehicle in an operational mode, may employ any wireless conventional tracking technology. Location tracking is not one single technology, but is oftentimes considered the convergence of several technologies that can be merged to create systems that track, for example, inventory, livestock or vehicle fleets. Similar systems are useful to deliver location-based services and tasks to or from wireless devices in accordance with the present invention.

Current technologies being used to create location-tracking and location-based systems include Geographic Information Systems (GIS) which capture, store, analyze and report geographic information. Also included are Global Positioning Systems (GPS) which include a constellation of 27 Earth-orbiting satellites (24 in operation and three extras in case one fails), and a GPS receiver, such as commonly included in a mobile phone, which can locate four or more of the satellites, figure out the distance to each, and deduce location through trilateration. For trilateration to work there must be a clear line of sight to the satellites. GPS is commonly used for outdoor positioning, such as surveying, farming, transportation or military use (for which it was originally designed). Additionally included is Radio Frequency Identification (RFID), which is a preferred embodiment in this invention, and Wireless Local Area Network (WLAN), which is a network of devices that connect via radio frequency, such as 802.11b, WLAN devices pass data over radio waves and provide users with a network with a range of 70 to 300 feet (21.3 to 91.4 meters). More recent inventions in the wireless communication field include Near Field Communication (NFC) to connect two or more wireless devices, and which encompass another preferred embodiment of the invention. A wireless location tracking or location-based service system may use one or a combination of these technologies, and all are contemplated for use in this invention.

In typical wireless tracking systems a node or tag is placed on or within an object, animal or person being tracked. For example, the GPS receiver in a cell phone or an RFID tag in a cell phone can be used to track or manipulate function of such devices with a detection system such as GPS satellites or RFID receivers.

RFID employs wireless non-contact use of radio-frequency electromagnetic fields to transfer data, and for the purposes of automatically identifying and tracking tags attached to objects. There are three types of RFID tags: active tags, which contain a battery and are constantly transmitting some sort of data such as vital signs; passive tags, which require external source such as a scanner to create a signal in an otherwise batteryless device; and battery assisted passive, which function as something of a hybrid of the two in that an external source is required to activate the battery functions. Each of these have their nuances of use, and all are contemplated for use in this invention.

RFID tags contain electronically stored information. Some tags are powered by and read at short ranges (a few meters) via magnetic fields (electromagnetic induction). Others use a local power source such as a battery, or else have no battery but collect energy from an interrogating electric magnetic (EM) field, and then act as a passive transponder to emit microwaves or UHF radio waves (i.e., electromagnetic radiation at high frequencies). Battery powered tags may operate at hundreds of meters. Unlike a barcode or GPS system, the tag does not necessarily need to be within a line of sight of a reader, and may be embedded in the tracked or manipulated object, such as the case with all new or modern smart phones capable of several manual-visual subtasks, including texting, e-mailing, map-reading and the like. Thus, RFID is becoming an attractive replacement for traditional UPC bar codes which depend on line of sight placement.

RFID is part of the family of Automatic Identification and Data Capture (AIDC) technologies that includes 1D and 2D bare codes. As mentioned, RFID uses an electronic chip, or tag usually applied to a substrate to form a label that is affixed to a product, case, pallet or other package or may be positioned somewhere within an object, or in the present invention usually comes incorporated in a smart phone capable of several visual-manual subtasks, such as texting, e-mail, etc., or may be simply affixed to a cell phone by any method such as glue or velcro. The information the tag contains may be read, recorded, rewritten or manipulated as desired or contemplated by an RFID interrogator or reader. RFID tags are used in many industries, such as an RFID tag attached to an automobile during production can be used to track its progress through the assembly line, pharmaceuticals can be tracked through warehouses, livestock and pets may have tags injected and allowing positive identification of the animal, and RFID tags can be attached to cash, clothing, everyday possessions such as an antitheft deterrent. As a RFID system uses tags, or labels attached to or embedded within the objects to be identified, two-way radio transmitter-receivers called interrogators or readers send a signal to the tag and read its response which may then be used to signal some manipulation of the response such as to activate an algorithm controlled app for controlling functionality of visual-manual subtasks in a smartphone and/or simultaneously disabling or enabling operation of a vehicle's motion, such as like an ignition key.

As mentioned an active tag has an on-board battery and periodically transmits its ID signal. A battery-assisted passive tag (BAP) has a small battery on board and is activated when in the presence of an RFID reader. A passive tag is cheaper and smaller because it has no battery. However, to start operation of passive tags, they generally must be illuminated with a power level roughly three magnitudes stronger than for signal transmission. Referring to some conventional examples, tags may either be read-only, having a factory-assigned serial number that is used as a key into a database, or may be read/write, where object-specific data can be written into the tag by the system user. Field programmable tags may be write-once, read-multiple and “blank” tags may be written with an electronic product code by a user.

RFID tags generally contain an integrated circuit for storing and processing information, modulating and demodulating a radio-frequency (RF) signal, collecting DC power from the incident reader signal, and other specialized functions; and an antenna for receiving and transmitting the signal. The tag information is stored in a non-volatile memory. The RFID tag includes either a chip-wired logic or a programmed or programmable data processor for processing the transmission and sensor data, respectively.

In similar manner to how a radio must be tuned to different frequencies to hear different channels, RFID tags and interrogators/readers should be tuned to the same frequency in order to communicate. There are several different frequencies a RFID tag can use, with the most common being Low Frequency (LF) (125-134 kHz); High Frequency (HF) (13.56 MHz); and Ultra-High Frequency (UHF) (433 and 860-960 MHz). Different frequencies provide different advantages in different applications. For example, LF RFID tags have a long wave length and are better able to penetrate thin metallic substances. LF RFID systems are also advantageous for objects with high water content such as fruits or beverages, but the read range is limited to inches. Thus, LF RFID typically is used in access control and animal tagging. HF RFID tags are seen as better suited for working on objects made of metal and on goods having a medium to high water content. HF RFID systems typically work in ranges of inches, with a maximum read range of about three feet, and are typically used to track library books, patient flow tracking and transit tickets.

UHF frequencies typically offer much better read range (inches to 50+ ft. depending on the RFID system setup) and can transfer data faster (i.e. read many more tags per second) than low- and high-frequencies. However, because UHF radio waves have a shorter wavelength, their signal is more likely to be attenuated (or weakened) and they cannot pass through metal or water. Due to their high data transfer rate, UHF RFID tags are well suited for many items at once, such as boxes of goods as they pass through a dock door into a warehouse or racers as they cross a finish line. Also, due to the longer read range, other common UHF RFID applications include electronic toll collection and parking access control.

Different countries allocate different bands of the radio spectrum for RFID, thus presently no single technology optimally satisfies all the requirements of existing and potential markets. Efforts have been made to standardize three main RF bands—low frequency, high frequency, and ultra-high frequency. Currently most countries have assigned the 125 or 134 kHz areas of the spectrum for low-frequency RFID systems, and 13.56 MHz is generally used around the world for high-frequency RFID systems.

UHF RFID systems have only been known since the mid-1990s, and many countries have not agreed on a single area of the UHF spectrum for RFID. Accordingly, different countries have different bandwidth and power restrictions for UHF RFID systems. Across the European Union, UHF RFID ranges from 865 to 868 MHz with RFID readers able to transmit at maximum power (2 watts ERP) at the center of that bandwidth (865.6 to 867.6 MHz).

In North America, the UHF RFID frequency ranges from 902 to 928 MHz with readers able to transmit at maximum power (1 watt ERP) for most of that bandwidth. Most other countries have either adopted the European Union or North America standard, or they are using a subset of one of the two bandwidths. As many non-RFID devices use the UHF spectrum, it may take several years for all governments to agree on a single UHF band for RFID but which in any event does not impact the present invention.

As mentioned, an RFID reader transmits an encoded radio signal to interrogate the tag. The RFID tag receives the message and then responds with its identification and other information and/or instructions or contemplated manipulation. This may be only a unique tag serial number, or may be product-related information such as a stock number, lot or batch number, production date, or other specific information or signal information such as to activate an app located or configured within an interrogator/reader.

To summarize, RFID systems can be classified by the type of tag and reader. A Passive Reader Active Tag (PRAT) system has a passive reader which only receives radio signals from active tags (battery operated, transmit only). The reception range of a PRAT system reader can be adjusted from 1-2,000 feet (0.30-609.60 m), allowing flexibility in applications such as asset protection and supervision. An Active Reader Passive Tag (ARPT) system has an active reader, which transmits interrogator signals and also receives authentication replies from passive tags. An Active Reader Active Tag (ARAT) system uses active tags awoken with an interrogator signal from the active reader. A variation of this system could also use a Battery-Assisted Passive (BAP) tag which acts like a passive tag but has a small battery to power the tag's return reporting signal.

Fixed readers are set up to create a specific interrogation zone which can be tightly controlled as used in the present invention. As advantageous to this invention this allows a highly defined reading area for when tags go in and out of the interrogation zone such as a cell phone carrying tag as per the present invention.

A summary of frequencies of RFID frequency bands are shown below.

Frequencies
RFID frequency bands

| Band | Regulations | Range | Data speed | Typical Application |
|---|---|---|---|---|
| 120-150 kHz (LF) | Unregulated | 10 cm | Low | Animal identification, factory data |
| | | | | collection |
| 13.56 MHz (HF) | ISM | 10 cm-1 m | Low to | Smart cards (MIFARE, ISO/IEC |
| | bandworldwide | | moderate | 14443) |
| 433 MHz (UHF) | Short Range | 1-100 in | Moderate | Defence applications, with active |
| | Devices | | | tags |
| 865-868 MHz | ISM band | 1-12 m | Moderate to | EAN, various standards |
| (Europe) | | | high | |
| 902-928 MHz (North | | | | |
| America) UHF | | | | |
| 2450-5800 MHz | ISM band | 1-2 m | High | 802.11 WLAN, Bluetooth standards |
| (microwave) | | | | |
| 3.1-10 GHz | Ultra wide band | to 200 m | High | requires semi-active or active tags |
| (microwave) | | | | |

Signaling between the reader and the tag is done in several different incompatible ways, depending on the frequency band used by the tag. Tags operating on LF and HF bands are, in terms of radio wavelength, very close to the reader antenna because they are only a small percentage of a wavelength away. In this near field region, the tag is closely coupled electrically with the transmitter in the reader. The tag can modulate the field produced by the reader by changing the electrical loading the tag represents. By switching between lower and higher relative loads, the tag produces a change that the reader can detect. At UHF and higher frequencies, the tag is more than one radio wavelength away from the reader, requiring a different approach. The tag can backscatter a signal. Active tags may contain functionally separated transmitters and receivers, and the tag need not respond on a frequency related to the reader's interrogation signal. All scenarios and different wavelengths and wavelength combinations are contemplated for use in this invention in one or more embodiments.

An Electronic Product Code (EPC) is one common type of data stored in a tag. When written into the tag by an RFID printer, the tag contains a 96-bit string of data. The first eight bits are a header which identifies the version of the protocol. The next 28 bits identify the organization that manages the data for this tag; the organization number is assigned by the EPC Global consortium. The next 24 bits are an object class, identifying the kind of product; the last 36 bits are a unique serial number for a particular tag. These last two fields are set by the organization that issued the tag. Rather like a URL, the total electronic product code number can be used as a key into a global database to uniquely identify a particular product.

Oftentimes more than one tag will respond to a tag reader, for example, many individual products with tags may be shipped in a common box or on a common pallet. This is analogous to the present invention as any smart phone with an RFID tag not with sending wavelength readability will respond to a tag reader coupled or associated with the cell phone system and receiving receptacle of the present invention. Collision detection is important to allow reading of data. Two different types of protocols may be used to “singulate” a particular tag, allowing its data to be read in the midst of many similar tags. In a slotted Aloha system, the reader broadcasts an initialization command and a parameter that the tags individually use to pseudo-randomly delay their responses. When using an “adaptive binary tree” protocol, the reader sends an initialization symbol and then transmits one bit of ID data at a time; only tags with matching bits respond, and eventually only one tag matches the complete ID string.

RFID offers advantages over manual systems or use of bar codes. The tag can be read if passed near a reader, even if it is covered by the object or not visible. The tag can be read inside a case, carton, box or other container, and thus, RFID tags used in conjunction with the present invention can be read in a receiving receptacle in which the phone is placed.

RFID technology is best suited for smaller spaces such as in the present invention in the drivers compartment of a vehicle, for example, or a plane cockpit, where the infrastructure is already in place to use it. RFID requires specialized scanners to read and transmit data. The dedicated infrastructure on a small, localized scale, has been shown to be very powerful for both tracking and for providing information, and including automatically scanning highway toll fees, using Zipcars, use of public transportation passes, preventing shoplifting, IDing livestock and identifying humans by passport.

GPS differs from RFID, as it also uses radio waves to transmit data, it does so using the global positioning system of 24 satellites, as opposed to specialized scanners. Radio waves sent out from this system of satellites transmit their time and orbital data to receivers down on Earth. Using the data from multiple satellites, receivers can then triangulate their position relative to the satellites, and thus on the Earth's surface. GPS, thus, is best suited for tracking anywhere in the world—but because of the sheer distance of the satellites, the signal is weaker, and is easier to jam, or even just not get a signal. Civilian models particularly are not as accurate in certain situations as desired, for instance at the bottom of a canyon or indoors. Emergency homing beacons, car trackers or navigational devices tend to be the most well known civilian uses, which don't require accuracy within a few inches, but happen on a large scale where no other infrastructure such as RFID or radio towers are set up. GPS is, by definition, global, and so the sort of tracking it's best at happens on the scales of tens or hundreds of miles, although such is still contemplated for use in this invention.

Near field communication (NFC) and Radio-Frequency Identification (RFID) are similar in that both are wireless communication technologies that connect two wireless devices. The devices in NFC are placed close to each other, while in RFID, they can be situated at some distance because it uses radio frequency, with limitations the same as that of radio waves. NFC can be used in mobile phones, while for radio frequency separate devices are needed. NFC technology is becoming more widely used as NFC technology is widely embedded in smartphones.

RFID is preferred over NFC in some applications because it has a wider spectrum of uses. The mechanism of RFID depends upon the radio frequency. All of RFID features are activated by using radio waves. As discussed above, a radio frequency can be active or passive, or sometimes both, but the NFC technology always works upon passive frequency. Additionally, the expected working range of NFC is a few centimeters, while for RFID it is in meters. Bluetooth and NFC both are short range technology for sharing and receiving. However, NFC requires less power than Bluetooth.

At a minimum, an RFID system comprises a tag, an interrogator/reader, and an antenna. The reader sends an interrogating signal to the tag via the antenna, and the tag responds with its unique information and/or initiates commands, such as by way of an app in a microcontroller in connection with the reader.

Returning to more preferred aspects of the invention, active RFID tags contain their own power source giving them the ability to broadcast with a read range of up to 100 meters. Their long read range makes active RFID tags ideal for many industries where location and other improvements in logistics are important. Passive RFID tags do not have their own power source and instead are powered by the electromagnetic energy transmitted from the RFID reader. Because the radio waves must be strong enough to power the tags, passive RFID tags have a read range from near contact and up to 25 meters. Passive RFID tags primarily operate at three frequency ranges: Low Frequency (LF) 125-134 kHz; High Frequency (HF)13.56 MHz; Ultra Frequency (UHF) 856 MHz to 960 MHz. Near-field communication devices operate at the same frequency (13.56 MHz) as HF RFID readers and tags. The standards and protocols of the NFC format is based on RFID standards outlined in ISO/IEC 14443, FeliCa, and the basis for parts of ISO/IEC 18092. These standards deal with the use of RFID in proximity cards.

As oftentimes referred to as a finely honed version of HF RFID, NFC devices have taken advantage of the short read range limitations of its radio frequency, because NFC devices must be in close proximity to each other, usually no more than a few centimeters, it has become a popular choice for secure communication between consumer devices such as smartphones, and as NFC technology becomes ubiquitous in smartphones the use of such technology is a preferred aspect of the present invention.

Additionally, Peer-to-peer communication is a feature that sets NFC apart from typical RFID devices. An NFC device is able to act both as a reader and as a tag. This unique ability has made NFC a popular choice for contactless payment, a key driver in the decision by influential players in the mobile industry to include NFC in most of the newer smartphones. Also, NFC smartphones pass along information from one smartphone to the other by tapping the two devices together, which turns sharing data such as contact info or photographs into a simple task, and which technology is preferred in the present invention.

Also, NFC devices can read passive NFC tags, and some NFC devices are able to read passive HF RFID tags that are compliant with ISO 15693. The data on these tags can contain commands for the device such as opening a specific mobile application. Because of such capability HF RFID tags and NFC tags are frequently used in advertisements, posters, and signs as it's an efficient method to pass information such as to consumers. In summary, NFC builds upon the standards of HF RFID and turns the limitations of its operating frequency into a unique feature of near-field communication.

Turning back to exemplified preferred embodiments of the invention a vehicle enabling mechanism of the cell phone system 10 for enabling and disabling a vehicle also includes communication means secured to the vehicle enabling mechanism for communicating enabling and disabling signals to one or more operating vehicle components of the vehicle such as coil ignition, fuel injection, brakes, etc., or in other embodiments may simply start sounding a vehicle horn and/or start flashing vehicle lights. The communication means may include any known technology for communicating signals capable of enabling and/or disabling the vehicle operating components such as a controller and a signal wire and wire connector secured in electrical communication with the controller and with the operating component. Alternative communication means may include wireless signal transmissions, such as, for example, OFDM-based signaling transmission described in the U.S. Pat. Nos. 7,548,875 and 8,423,427, of which the entire disclosures thereof are incorporated herein by reference, electro-mechanical signal transmitters, or any other communicating means known in the art to be capable of the described functions.

By use of wireless technology, such as RFID/NFC, wireless compressed signals and the like, there is no need for easily disrupted and/or bypassed bar code readers with attendant reader heads or an optical bar code scanner which must consistently read a bar coded information strip to work or perform correctly, or as intended. For example, with such bare code scanners it is necessary that bare code information be place in an exacting position on the reader head, and which may be a consistent problem with ever-changing cell phone configurations and dimensions

In preferred embodiments it is contemplated the present inventive device and methods will operate in an analogous manner to present day auto breathalyzers. Auto breathalyzer devices, also called Ignition Interlock Devices (IID) are small devices that are about the size of a cell phone, with the device connection to a vehicle's ignition system. Prior to starting the vehicle, an operator is required to blow into the device to submit a breath sample. The device measures breath alcohol level and compares it to a pre-set limit. If breath alcohol level is below a pre-set limit, the vehicle will start. If breath alcohol level is at or above the pre-set level, the IID will prevent the vehicle from starting. In other embodiments, while the vehicle is being operated, the IID will alert a driver or operator to submit a breath sample. Such breath samples are random and are typically required several times while operating the vehicle. If the device detects a breath alcohol level above the pre-set limit while driving, depending on a jurisdiction, the device will sound an alarm and may also trigger the vehicle's horn and/or flash the lights until the vehicle is turned off. For safety reasons, the IID will not turn off the vehicle if breath alcohol level is above the pre-set limit while operating the vehicle. Some devices also notify law enforcement or otherwise an administrator if breath alcohol level is above the pre-set limit while operating the vehicle.

In analogous manner the present inventive cell phone system will act similarly to auto breathalyzer devices by enabling motion of a vehicle or at least one or more operational functions of a vehicle upon placing a cell phone in, for example, an RFID/NFC enabled receptacle, preferably a NFC enabled receptacle, in which a reader/interrogator by way of being triggered by a cell phone's presence carrying an RFID/NFC tag activates an application to enable operational vehicle functions, and to simultaneously, or at least substantially simultaneously, disable cell phone functions, such as various visual-manual subtasks including of texting in accordance with the invention; and if the device is tampered with in any way during vehicle operation the device may set off an alarm, trigger the vehicle's horn and/or flash its headlights until the vehicle is turned off. For safety reasons the device will not disable the vehicle while being operated and there is also an optional mode of notification of an administer if the device is tampered with.

The vehicle enabling mechanism is configured or manufactured such that positioning of the cell phone 14 within the receiver receptacle 22 activates the vehicle enabling mechanism to put the vehicle operating components in the enabled mode for normal operation of the vehicle, and so that removal of the cell phone 14 from the receiver receptacle deactivates the vehicle enabling mechanism to put the vehicle operating components in the disabled mode, for instance by way of power cable with plug in 24 in FIG 1. The vehicle enabling mechanism including its controller may be configured and manufactured for communicating with the vehicle operating components of the vehicle through known methods and apparatus such as described, for example, in U.S. Pat. No. 7,363,129 to Barnicle et al. which describes both wired and wireless communication with Engine Control Units (“ECUs”), and which disclosure of U.S. Pat. No. 7,363,129 is hereby incorporated herein by reference. The controller generates signals in a manner comparable to known “remote-control car starters” that permit start up of a vehicle from a remote distance by compression of a spring-biased button in a hand-held switch (not shown). The controller of the vehicle enabling mechanism when activated similarly generates an engine-operation signal and communicates it to an ECU of the engine of the vehicle. When the vehicle enabling mechanism is deactivated, either the engine-operation signal is interrupted, or an engine disabling signal is generated and communicated to the ECU to disable one or more vehicle operating components. The vehicle operating component disabling signal may be the same form of control signal as generated in known vehicles by turning off and removing an ignition key.

Although the receiving receptacle 22 is shown in the described embodiments as a stand-alone, box-like structure in FIG. 1, it is to be understood that the receiving receptacle 22 may be in any form that permits the described functions. For example, the receiving receptacle 22 may be integral with the vehicle, such as within or under the dashboard in the form of a receiving sleeve or port with no cover so that the cell phone 20 is simply inserted into or just placed into the receiving receptacle 22. The receiving receptacle 22 may be any structure that can house the vehicle enabling mechanism in such a manner that the mechanism can interact with the cell phone 14 to enable the vehicle operating components. While communication between the vehicle enabling mechanism and the vehicle operating components of the vehicle has been described as communication through an ECU, it is to be understood that the vehicle enabling mechanism may communicate with any operating component of the vehicle so that the normal operating of the vehicle is enabled to permit motion of the vehicle. Such communication may be by way of the ECU, or any other known vehicle control apparatus that may put the vehicle in an enabled mode.

The present disclosure also includes a method of enabling and disabling vehicle operating components through the steps of securing enabling information to the cell phone; constructing the receiving receptacle 22 so that placement of the cell phone 14 within the receiving receptacle 22 prohibits transmission of communication signals from the cell phone 14; securing the vehicle enabling mechanism within the receiving receptacle 22; securing the receiving receptacle 22 within the vehicle; inserting the cell phone 14 within the receiving receptacle 22 to activate vehicle operating components enabling mechanism to thereby put the vehicle in an enabled mode for permitting motion of the vehicle; and removing the cell phone 14 from the receiving receptacle 22 to deactivate the vehicle enabling mechanism to thereby put the vehicle in a disabled mode for preventing or inhibiting motion of the vehicle.

In still other preferred embodiments, the present invention may include scenery analyzer capability and/or functionality coupled to wireless vehicle disabling/enabling mode, such as RFID and/or NFC functionality, and configured to determine whether a holder of a cell phone or other communication device is located within a safe operating area of a vehicle, such as disclosed, for example, in U.S. Pat. No. 8,706,143. The scenery analyzer can be configured to determine whether a holder of handheld communication device, such as a smartphone, is located within safe operating area of a vehicle in preferred embodiments based on picture data or video data if a handheld communication device has a camera. For example, the holder of the device can be required to pan the camera around the vehicle (e.g., 360 degrees), so that the camera can take either a series of pictures or a video. The picture/video data can be digitally analyzed by scenery analysis programming in the handheld communication device to determine if the holder of the device is deemed to be in safe operating area within the vehicle. The scenery analysis programming can be based on any suitable algorithm. In one embodiment, for example, the algorithm may specify that if the picture/video data shows only one face and a vehicle operating mechanism (e.g., a steering wheel in an embodiment in which the vehicle is an automobile) in separate images, then it may be determined that the holder of the device is in a driver compartment area of the vehicle e.g., such as in the driver seat within unsafe operating area of a vehicle. The algorithm may also specify that if the picture/video data shows more than one face and a vehicle operating mechanism, with one of the faces and the vehicle operating mechanism in one image or video frame, then it may be determined that the holder of the device is not in the driver compartment area of the vehicle, but rather in a passenger compartment area of the vehicle such as in the front passenger seat within safe operating area of vehicle. Further, the algorithm may specify that if the picture/video data does not show a vehicle operating mechanism, then it may be determined that the holder of the device is in a passenger compartment area of the vehicle e.g., such as in a rear seat within safe operating area of a vehicle, or in a passenger compartment area in some other form of transportation, such as a train. In order to prevent the holder of handheld communication device from tilting the camera in different ways during a panning operation, such as to avoid capturing an image of the vehicle operating mechanism if the holder is in a driver compartment area of a vehicle, the scenery analysis programming can use accelerometer output to ensure that level and proper panning is implemented.

In yet a further aspect of the invention, there is provided a lock box device in which a driver of a vehicle places a handheld communication device in the lock box, then locks the box which sends a signal as discussed herein to enable one or more vehicle operational components, or otherwise to enable vehicle operation, such as driving an automobile. Should the lock box be tampered with prior to attempted vehicle operation, the vehicle will be disabled from operation by signal(s) from the lock box, and the vehicle will be prevented from operation. Should the lock box be tampered with while operating the vehicle, such as in an attempt to use the communication device in any way, such as e-mail, texting or talking, the vehicles horn and/or lights will be activated, such as continuous horn blasts or flashing lights as a deterrence measure in similar manner to IID breathalyzer devices discussed herein.

In embodiments of this aspect of the invention RFID/NFC may also be employed with various frequencies of a tag/reader combination employed, such as a tag embedded in a cell phone or attached or associated with a cell phone being detected in near proximity to a vehicle operational controls, such as a predetermined distance from an automobile steering wheel or other vehicle operational feature located near a vehicle operator's position or compartment such as the steering/operating yoke of a plane, or otherwise a communication device used in a so called “danger zone”. A communication device not detected within a predetermined danger zone will not affect/effect a vehicle operation/operability and communication device's function(s), such as a cell phone e-mailing and texting capabilities.

Additionally contemplated for use in this invention is the use of RFID/NFD connectability with I²C connection with RFID/NFC connected directly to microcontrollers and ASIC in controlling vehicle operation and prohibiting unauthorized texting and e-mailing

While the present disclosure has been presented above with respect to the described and illustrated embodiments of a cell phone system for enabling and disabling a vehicle and simultaneously a cell phone or other mobile communication device, it is to be understood that the disclosure is not to be limited to those alternatives and described embodiments and preferred embodiments. Various modifications, which will become apparent to one skilled in the art fall within the scope of this invention including as described in the attached claims.

1. A communications device system for simultaneously enabling and disabling a vehicle and a mobile communications device, the vehicle being for transporting at least a vehicle operator, the vehicle having an enabled mode for permitting motion of the vehicle and a disabled mode for preventing motion of the vehicle, the system comprising: mobile communications device for transmitting and receiving communication signals, the communications device having a fully operational mode for permitting transmission and reception of communication signals and an idle mode for preventing transmission of communication signals; a receiving receptacle secured within the vehicle and configured for receiving and securing the communications device within receiving receptacle so that the communications device is in the idle mode whenever the communications device is secured within the receiving receptacle; and, a vehicle enabling mechanism secured within the receiving receptacle and secured in communication with one or more operating components of said vehicle, the vehicle enabling mechanism being configured so that placement of the communication device into the receiving receptacle activates the vehicle enabling mechanism to put the vehicle in the enabled mode, and so that removal of the communication device from the receiving receptacle deactivates the vehicle enabling mechanism to put the vehicle in the disabled mode by way of RFID.

2. The cell phone system of claim 1, which operates by way of NFC.

3. The communications device system of claim wherein the communications device is a smartphone.

4. The communications device system of claim 1, further comprising the receiving receptacle including an auto lock, wherein the auto lock automatically locks a top of the receiving receptacle.

5. The communications device system of claim 1, further comprising a by-pass card or code having a by-pass information configured so that placement of the by-pass card or code into the receiving receptacle activates the vehicle enabling mechanism to put the vehicle in the enabled mode, and so that removal of the by-pass card or code from the receiving receptacle deactivates the vehicle enabling mechanism to put the vehicle in the disabled mode.

6. The communications device system of claim 1, wherein the receiving receptacle is integral with a dashboard of the vehicle.

7. The communications device system of claim 1, wherein the receiving receptacle is a retro-fit receiving receptacle secured to the vehicle.

8. A method of using a cell phone to enable and disable a vehicle, the vehicle being for transporting at least a vehicle operator, the vehicle having an enabled mode for permitting motion of the vehicle and a disabled mode for preventing motion of the vehicle, the method comprising: applying enabling information to the cell phone by way of RFID and affective enabling algorithm; providing a receiving receptacle so that placement of the cell phone within the receiving receptacle prohibits transmission of communication signals from the cell phone; securing a vehicle enabling mechanism within the receiving receptacle; securing the receiving receptacle within the vehicle; then securing the cell phone within the receiving receptacle to activate the vehicle enabling mechanism to thereby put the vehicle in an enabled mode for permitting motion of the vehicle; and, then removing the cell phone from the receiving receptacle to deactivate the vehicle enabling mechanism to thereby put the vehicle in a disabled mode for preventing motion of the vehicle.

9. The method of using a cell phone to enable and disable a vehicle of claim 10, wherein the step of applying enabling information to the cell phone further comprises applying an RFID or NFC tag to the cell phone.

10. The method of using a cell, phone to enable and disable a vehicle of claim 10, further comprising replacing the step of then securing the cell phone within the receiving receptacle with a step of securing a by-pass card within the receiving receptacle, and replacing the step of removing the cell phone from the receiving receptacle with a step of removing the bypass card from the receiving receptacle.

11. A method of prohibiting operation of a specific cell phone by a specific vehicle operator while the vehicle is in an enabled mode, the method comprising:
identifying the vehicle operator as a high-risk operator; applying enabling information to the cell phone by way of RFID and an effective enabling algorithm; providing a receiving receptacle so that placement of the cell phone within the receiving receptacle prohibits transmission of communication signals from the cell phone; securing a vehicle enabling mechanism within the receiving receptacle; securing the receiving receptacle within the vehicle; then securing the cell phone within the receiving receptacle by the high-risk vehicle operator to activate the vehicle enabling mechanism to thereby put the vehicle in an enabled mode for permitting operation of the vehicle by the high-risk driver; and, then removing the cell phone from the receiving receptacle by the high-risk vehicle operator to deactivate the vehicle enabling mechanism to thereby put the vehicle in a disabled mode for preventing motion of the vehicle.

12. The method of prohibiting operation of a specific cell phone by a specific vehicle operator while the vehicle is in an enabled mode of claim 1, wherein the step of applying enabling information to the cell phone further comprises applying an RFID tag to the cell phone.
